(19) United States
(12) Patent Application Publication
(10) Pub. No.: US 2024/0182726 A1
(43) Pub. Date: Jun. 6, 2024

(54) SPRAYABLE COOL WHITE COATING BASED ON CERAMIC MICROSPHERES

(71) Applicant: THE REGENTS OF THE UNIVERSITY OF CALIFORNIA, Oakland, CA (US)

(72) Inventors: Xiao Nie, Irvine, CA (US); Jaeho Lee, Irvine, CA (US)

(21) Appl. No.: 18/552,959

(22) PCT Filed: Mar. 29, 2022
(86) PCT No.: PCT/US22/22349

§ 371 Date: Sep. 28, 2023

Related U.S. Application Data
(60) Provisional application No. 63/167,416, filed on Mar. 29, 2021.

(51) Int. Cl. C09D 7/61; C09D 1/00; C09D 5/33; C09D 7/20; C09D 7/40

(52) U.S. Cl. CPC C09D 7/61; C09D 1/00; C09D 5/004; C09D 7/20; C09D 7/68; C09D 7/69

(57) ABSTRACT

A coating solution that is sprayable and reflective across the UV, visible, and near-infrared wavelength ranges is described herein. Potassium bromide is used as a binder to integrate microscale ceramic bubbles. The spray coating not only provides high reflectivity all across the solar wavelengths, but also a high mid-infrared emissivity for effective surface cooling in ambient environments. Tests with concrete samples show that the spray coating allowed for significantly more cooling compared to commercially available white paints and even sub-ambient cooling under sunlight.

### CROSS-REFERENCES TO RELATED APPLICATIONS

This application claims benefit of U.S. Provisional Application No. 63/167,416 filed Mar. 29, 2021, the specification(s) of which is/are incorporated herein in their entirety by reference.

### BACKGROUND OF THE INVENTION

Considering the large amount of solar irradiation an object in deep space or on Earth's surface receives, a wide variety of thermal control coatings or optical coatings were developed to aid in thermal management of objects. Among these coatings, optical coatings for sunlight reflection shield solar irradiation within the ultraviolet (UV), visible and near-infrared (near-IR) wavelength region to prevent surface heating, which enables their intensive study in spacecraft thermal control, surface cooling in buildings, and photovoltaic concentration systems.

Optical coatings for sunlight reflection or surface cooling in the ambient environment require a high reflectivity across the UV, visible, and near-IR spectrum. An ideal solar-reflective coating may significantly reduce air-conditioning loads and related energy consumptions of buildings or outdoor systems that are constantly exposed to sunlight. However, the sunlight-reflection property of commercial white paints is often limited to the visible wavelength range and not very effective in the UV or in the near-IR wavelength range due to the popular use of titanium dioxide (TiO₂) pigments.

In recent literature, nanocomposites using silicon (Si), silicon dioxide (SiO₂)-based layered structures, or metallic reflectors have demonstrated considerable surface cooling properties; however, their processing requirements and costs are inappropriate for large-scale applications such as cooling buildings. The use of inexpensive materials and scalable processing is necessary. To address these aspects, randomly-packed SiO₂ microsphere glass bubbles have been demonstrated with polymer composites and showed promising surface cooling properties in ambient environments. Previous work on glass bubble composites relied on a spin-coating method in which the sample demonstration was limited to a Petri dish size and required a polydimethylsiloxane (PDMS) as a binder, which limited the near-infrared reflection. New processing approaches that are scalable and do not require spin-coating or PDMS are necessary.

### BRIEF SUMMARY OF THE INVENTION

It is an objective of the present invention to provide compositions that allow for a sprayable coating that is used for effective sunlight reflection, passive cooling, and energy savings for buildings and space applications, as specified in the independent claims. Embodiments of the invention are given in the dependent claims. Embodiments of the present invention can be freely combined with each other if they are not mutually exclusive.

While most selective emitter materials are inadequate or inappropriate for building applications, the present invention features a techno-economically viable coating solution that is sprayable and reflective across the UV, visible, and near-IR wavelength ranges. The spray coating not only provides high reflectivity all across the solar wavelengths, but also a high mid-IR emissivity for effective surface cooling in ambient environments. The spray coating is easy to fabricate and the materials are environmentally friendly and easy to obtain.

One of the unique and inventive features of the present invention is the use of potassium bromide (KBr) in the spray coating. Instead of using PDMS, KBr is used as the binder to hold the glass bubbles. Without wishing to limit the invention to a particular theory or mechanism, the use of KBr is important for the present invention because it is solar transparent compared to other organic or inorganic binders. None of the presently known prior references or work has this unique inventive technical feature.

Furthermore, the temperature reduction effect of the spray-coated glass bubbles is more significant compared to commercial white paint. Without wishing to limit the invention to a particular theory or mechanism, the spray coating had a higher solar reflectivity (especially in the UV and near-IR wavelengths) than commercial TiO₂-based white paint and provided significant surface cooling when coated on concrete surfaces. Tests with concrete samples surprisingly showed that the spray-coated glass bubbles offered significantly more cooling compared to commercially available white paints and even sub-ambient cooling under sunlight when convection is limited. Analysis of the spray-coated glass bubbles indicates that the net cooling power of the spray-coated glass bubbles is greater than 76 W/m².

According to some embodiments, the present invention features a coating composition comprising ceramic microspheres and a binder in a solvent. The composition can have a high solar reflectivity ranging from 0.9-1. A weight ratio of the ceramic microspheres to the binder can be 3:7. In some embodiments, a net cooling power of the coating composition is greater than 70 W/m².

In some embodiments, the ceramic microspheres are SiO₂ bubbles, TiO₂ bubbles, Al₂O₃ bubbles, or Y₂O₃ bubbles. In one embodiment, the ceramic microspheres can have a diameter ranging from about 1 μm to about 40 μm. In another embodiment, the ceramic microspheres can have a shell thickness ranging from about 0.05 μm to about 2 μm.

In other embodiments, the binder is solar transparent. Non-limiting examples of solar transparent binders include KBr, potassium chloride (KCl), cesium bromide (CsBr), barium fluoride (BaF₂), calcium fluoride (CaF₂), magnesium fluoride (MgF₂), strontium fluoride (SrF₂), sodium chloride (NaCl), and sodium fluoride (NaF).

In some embodiments, the solvent is water. A weight % of the solvent may range from about 60% to about 90%. As a non-limiting example, the coating composition may comprise, by weight, 3 parts glass bubbles, 7 parts binder, and 25 parts water.

In some aspects, the coating composition for reducing a temperature may comprise glass bubbles and KBr in water. In a non-limiting embodiment, the weight ratio of the glass bubbles to potassium bromide to water is 3:7:20-50.

According to other embodiments, the present invention features a method of preparing a coating solution for reducing a temperature. The method may comprise adding a binder and ceramic microspheres to a solvent, and mixing the binder, ceramic microspheres, and the solvent.

In yet other embodiments, the present invention features a method for coating a substrate. The method may comprise providing a coating solution comprising a binder and ceramic microspheres in a solvent, and applying said coating solution on the substrate. In preferred embodiments, the coating solution can reduce a temperature of the substrate.

In some embodiments, the coating solution is sprayed onto the substrate. In other embodiments, the method may further comprise drying the substrate so as to evaporate the solvent, thereby producing a coating comprising the binder and ceramic microspheres on the substrate. In some embodiments, the substrate is an exterior surface of a building or a spacecraft.

Any feature or combination of features described herein are included within the scope of the present invention provided that the features included in any such combination are not mutually inconsistent as will be apparent from the context, this specification, and the knowledge of one of ordinary skills in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows the fabrication process of the spray coating composition according to an embodiment of the present invention.

FIG. 2 illustrates the heat transfer on a surface coated with the spray coating composition of the present invention.

### DETAILED DESCRIPTION OF THE INVENTION

As used herein, the term “solar reflectivity” refers to a fraction of the incident solar energy which is reflected by a surface in the solar region whose wavelength range is around 0.2-2.5 μm. Solar reflectivity ranges from 0 to 1, where a solar reflectivity of 0 indicates a material absorbs all solar energy and a value of 1 indicates total reflectance. A high value for solar reflectivity is considered to be from about 0.8 to 1.

As used herein, ultraviolet (UV) is a form of electromagnetic radiation with a wavelength range of 0.2-0.4 μm. Visible is a form of electromagnetic radiation with a wavelength range of 0.4-0.8 μm. Near-infrared (IR) is a form of electromagnetic radiation with a wavelength range of 0.8-2.5 μm.

As used herein, the term “transparent” refers to a physical property of a material to allow light to pass through without appreciable scattering or absorption of light. For example, a material that is UV transparent allows for UV light to pass through it.

As used herein, the term “microspheres” refers to spherical particles having diameters in the micron range. For example, the diameters of the microspheres may range from about 1 μm to about 40 μm. The term “microsphere” can be used interchangeably with “bubbles”. In some embodiments, the microspheres are solid. In other embodiments, the microspheres are hollow. The hollow microspheres can have a shell thickness of about 0.05 μm to 2 μm.

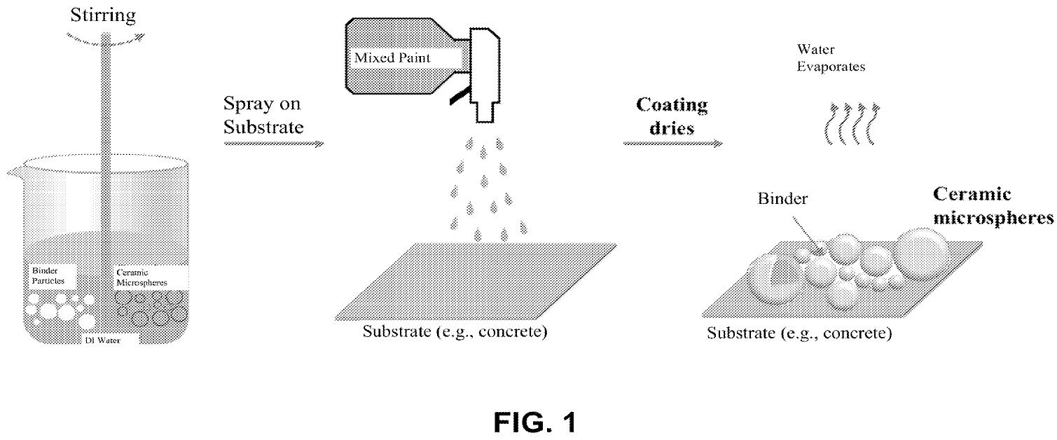

According to some embodiments, the present invention features a coating composition with high solar reflectivity. In some embodiments, the coating composition may comprise a binder, a solvent, and microspheres. In preferred embodiments, the coating composition is sprayable, i.e., the coating composition can be dispensed from a spraying apparatus, as shown in FIG. 1.

In one embodiment, the microspheres can be ceramic microspheres, also referred to herein as glass bubbles. As known to one with ordinary skill in the art, glass is considered as a ceramic material. Non-limiting examples of ceramic microspheres include SiO₂ bubbles, TiO₂ bubbles, Al₂O₃ bubbles, and Y₂O₃ bubbles.

In some embodiments, the ceramic microspheres have diameters ranging from about 1 μm to about 40 μm. For example, the ceramic microspheres can have diameters ranging from about 1 μm to about 10 μm, or about 10 μm to about 25 μm, or about 20 μm to about 35 μm, or about 30 μm to about 40 μm. In other embodiments, the ceramic microspheres have a shell thickness of about 0.05 μm to 2 μm. For example, the ceramic microspheres are hollow and have a shell thickness ranging from about 0.05 μm to about 1 μm, or about 1 μm to about 1.5 μm, or about 1.5 μm to about 2 μm.

In some embodiments, the binder is solar transparent. In some preferred embodiments, the binder is potassium bromide (KBr). Without wishing to limit the invention to a particular theory or mechanism, KBr is important for the composition because it is solar transparent as compared to other organic or inorganic binders, meaning that KBr is transparent in the wavelength range of around 0.2-2.5 μm.

However, the binder is not limited to KBr. Other examples of binders include chloride materials, bromide materials, or fluoride materials. In preferred embodiments, the chloride materials, bromide materials, or fluoride materials are solar transparent. Non-limiting examples of such binders include barium fluoride (BaF₂), calcium fluoride (CaF₂), magnesium fluoride (MgF₂), strontium fluoride (SrF₂), sodium chloride (NaCl), and sodium fluoride (NaF).

In some embodiments, the weight ratio of the microspheres to the binder is about 3:7. In other embodiments, the weight ratio of the microspheres to the binder can range from about 0.1 to about 0.5. In yet other embodiments, the weight ratio of the microspheres to the binder can range from about 0.1 to about 0.3, or about 0.3 to about 0.4, or about 0.4 to 0.5.

In other embodiments, a weight % of the microspheres in the coating composition may range from about 2% to about 17%. For example, the weight % of the microspheres is about 2% to about 10%, or about 5% to about 12%, or about 8% to about 17%. In some other embodiments, a weight % of the binder in the coating composition may range from about 5% to about 25%. For example, the weight % of the binder is about 5% to about 15%, or about 10% to about 20%, or about 15% to about 25%.

In some embodiments, the solvent is water. For instance, the solvent may be deionized water. In some embodiments, a weight % of the solvent may range from about 60% to about 90%. In other embodiments, a weight % of the solvent may range from about 60% to about 75%, or about 70% to about 85%, or about 80% to about 90%. For example, the coating composition may comprise, by weight, 3 parts glass bubbles, 7 parts binder, and 20-30 parts water. As another example, the coating composition may comprise, by weight, 3 parts glass bubbles, 7 parts binder, and 40-50 parts water.

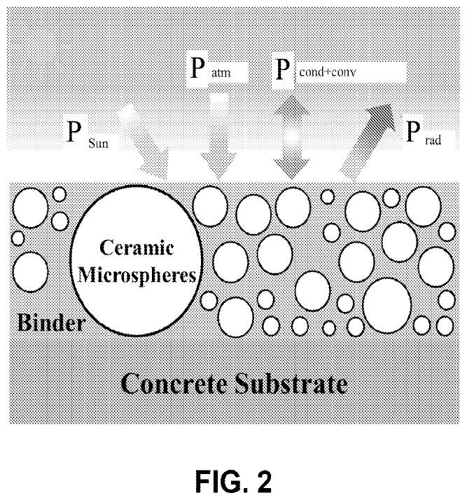

In preferred embodiments, the coating composition has a solar reflectivity of about 0.9 to 1. In other embodiments, the net cooling power of the coating composition is greater than 70 W/m². For example, the net cooling power of the coating composition may be greater than 76 W/m². As used herein, the term “cooling power” is the ability to remove heat. A non-limiting example of heat transfer in a surface coated with the coating composition is shown in FIG. 2, where P is power.

In some embodiments, the coating composition can be used to coat an exterior surface of a building. Non-limiting examples of buildings include residential, educational, and commercial buildings. Examples of building materials that may be coated with the coating composition include, but are not limited to, concrete, brick, wood, metal, tile, stucco, clay, or vinyl.

Other non-limiting examples of applications for the coating composition described herein include coating spacecraft. Without wishing to limit the invention to a particular theory or mechanism, the coating composition is able to cool buildings, spacecrafts, or any other surface on which said coating composition is applied.

In a non-limiting embodiment of the present invention, the coating composition comprises KBr as a binder, glass bubbles as the microspheres, and water as the solvent. To prepare said coating composition, KBr, water, and the glass bubbles are mixed together. The weight ratio of glass bubbles to KBr to water is 3:7:20-50. In one embodiment, the glass bubbles are SiO₂ bubbles. Without wishing to limit the invention to a particular theory or mechanism, the coating composition has a high solar reflectivity and allows for reducing temperature.

According to some embodiments, the present invention provides a method for preparing a coating solution. The coating solution may be according to any embodiment of the coating compositions described herein. In some embodiments, the method may comprise mixing microspheres and a binder in a solvent. In preferred embodiments, a weight ratio of the microspheres to the binder to water is 3:7:20-50. Non-limiting examples of the microspheres include ceramic microspheres such as SiO₂ bubbles, TiO₂ bubbles, Al₂O₃ bubbles, and Y₂O₃ bubbles. In some embodiments, the binder may be KBr, KCl, CsBr, BaF₂, CaF₂, MgF₂, SrF₂, NaCl, and NaF. In other embodiments, the solvent is water.

According to other embodiments, the present invention provides a method for coating a substrate. The method comprises providing a coating solution comprising a mixture of microspheres and a binder in a solvent, and applying the coating solution on a substrate, thus coating the substrate. In other embodiments, the method may further comprise drying the substrate to evaporate the solvent, thereby leaving a coating of the microspheres and binder on the substrate. The coating solution may be according to any embodiment of the coating compositions described herein. In one embodiment, the weight ratio of the microspheres, the binder, and water is 3:7:20-50.

In preferred embodiments, the coating solution is sprayed onto the substrate. For example, the coating solution may be sprayed onto the substrate using a spraying apparatus, such as a spray bottle or a commercial sprayer. In alternative embodiments, the substrate may be dipped, partly or completely submerged, in the coating solution. In some embodiments, the coating solution is dried under ambient conditions or with heat.

In some embodiments, the substrate may be a surface. For example, the substrate may be an exterior surface of a building. Examples of buildings include, but are not limited to, residential, educational, and commercial buildings. Examples of building materials that may be coated with the coating composition include, but are not limited to, concrete, brick, wood, clay, stucco, tile, metal, or vinyl. In non-limiting embodiments, the surface may be a concrete exterior wall of a commercial building or a clay tile roof and brick exterior walls of a residential building. In other embodiments, the substrate may be a spacecraft. Without wishing to limit the present invention to any theory or mechanism, the coating can lower the temperature of the building or the spacecraft. For example, the coating may lower the temperature of the building by up to about 20° C.

### Example

The following is a non-limiting example of the present invention. It is to be understood that said example is not intended to limit the present invention in any way.

Equivalents or substitutes are within the scope of the present invention.

### Fabrication of a Cool White Spray Coating

Referring to FIG. 1, commercially available SiO₂ bubbles were mixed with potassium bromide (KBr) in a weight ratio of 3:7, and about 20 parts DI water was added to make the solution. After thoroughly stirring, the solution was added into a commercial spray bottle and the spray bottle was used to spray the solution onto a concrete surface. The coated concrete surface was left at room temperature to evaporate the solvent, thereby forming a coating comprising the SiO₂ bubbles and potassium bromide on the concrete surface.

### Example 2 of a Spray Coating

About 2-4 parts of commercially available SiO₂ bubbles are mixed with about 7-10 parts potassium chloride, and about 20-30 parts DI water is added to make the solution. After thoroughly stirring, the solution is added into a commercial spray bottle and the spray bottle is used to spray the solution onto a surface that needs to be coated.

### Example 3 of a Spray Coating

About 1-3 parts of commercially available Y₂O₃ bubbles, about 8-10 parts cesium bromide, and about 40-50 parts DI water are added together to make the solution. After thoroughly stirring, the solution is added into a commercial spray bottle and the spray bottle is used to spray the solution onto a surface that needs to be coated.

As used herein, the term “about” refers to plus or minus 10% of the referenced number. Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

1. A coating composition comprising ceramic microspheres and a binder in a solvent.

2. The composition of claim 1 having a high solar reflectivity ranging from 0.9-1.

3. The composition of claim 1, wherein the ceramic microspheres are SiO₂ bubbles, TiO₂ bubbles, Al₂O₃ bubbles, or Y₂O₃ bubbles.

4. The composition of claim 1, wherein the ceramic microspheres have a diameter ranging from about 1 μm to about 40 μm.

5. The composition of claim 1, wherein the ceramic microspheres have a shell thickness ranging from about 0.05 μm to about 2 μm.

6. The composition of claim 1, wherein the binder is solar transparent.

7. The composition of claim 1, wherein the binder is potassium bromide (KBr), potassium chloride (KCl), cesium bromide (CsBr), barium fluoride (BaF₂), calcium fluoride (CaF₂), magnesium fluoride (MgF₂), strontium fluoride (SrF₂), sodium chloride (NaCl), or sodium fluoride (NaF).

8. The composition of claim 1, wherein the solvent is water.

9. The composition of claim 1, wherein a weight ratio of the ceramic microspheres to the binder is 3:7.

10. (canceled)

11. A coating composition for reducing a temperature, comprising glass bubbles and potassium bromide in water.

12. The composition of claim 11, wherein a weight ratio of the glass bubbles to potassium bromide is 3:7.

13. A method of preparing a coating solution for reducing a temperature, the method comprising:
a. adding a binder and ceramic microspheres to a solvent; and
b. mixing the binder, ceramic microspheres, and the solvent.

14. The method of claim 13, wherein the coating solution has a high solar reflectivity ranging from 0.9-1.

15. The method of claim 13, wherein the ceramic microspheres are SiO₂ bubbles, TiO₂ bubbles, Al₂O₃ bubbles, or Y₂O₃ bubbles.

16. The method of claim 13, wherein the ceramic microspheres have a diameter ranging from about 1 μm to about 40 μm.

17. The method of claim 13, wherein the ceramic microspheres have a shell thickness ranging from about 0.05 μm to about 2 μm.

18. The method of claim 13, wherein the binder is solar transparent.

19. The method of claim 13, wherein the binder is potassium bromide (KBr), potassium chloride (KCl), cesium bromide (CsBr), barium fluoride (BaF₂), calcium fluoride (CaF₂), magnesium fluoride (MgF₂), strontium fluoride (SrF₂), sodium chloride (NaCl), or sodium fluoride (NaF).

20. The method of claim 13, wherein the solvent is water.

21. The method of claim 13, wherein a weight ratio of the ceramic microspheres to the binder is 3:7.

22-34. (canceled)
